(19) United States
(12) Patent Application Publication
(10) Pub. No.: US 2025/0316703 A1
(43) Pub. Date: Oct. 9, 2025

(54) SECONDARY BATTERY AND ELECTRONIC APPARATUS

(71) Applicant: Dongguan Amperex Technology Limited, Dongguan (CN)

(72) Inventors: Xiaoping LIN, Dongguan (CN); Yuansen XIE, Dongguan (CN)

(73) Assignee: Dongguan Amperex Technology Limited, Dongguan (CN)

(21) Appl. No.: 19/003,754

(22) Filed: Dec. 27, 2024

(30) Foreign Application Priority Data
Dec. 29, 2023 (CN) 202311862376.9

(51) Int. Cl. H01M 4/62; H01M 4/02; H01M 4/133; H01M 10/0567

(52) U.S. Cl. CPC H01M 4/628; H01M 4/133; H01M 4/622; H01M 10/0567; H01M 2004/027; H01M 2300/0025

(57) ABSTRACT

A secondary battery includes a negative electrode plate, wherein the negative electrode plate includes a negative electrode current collector and a negative electrode material layer disposed on at least one surface of the negative electrode current collector, and a cohesion of the negative electrode material layer is Z N/m, wherein 15≤Z≤45; and the negative electrode material layer includes a negative electrode active material, a solid electrolyte material, and a negative electrode binder, the solid electrolyte material includes lanthanum, and based on a mass of the negative electrode material layer, a mass percentage of lanthanum is a, wherein 0.16%≤a≤5%.

### CROSS-REFERENCE TO RELATED APPLICATION

The present application claims priority to Chinese Patent application No. CN 202311862376.9 filed in the China National Intellectual Property Administration on Dec. 29, 2023, the entire content of which is hereby incorporated by reference.

### TECHNICAL FIELD

This application relates to the field of electrochemical technologies, and in particular, to a secondary battery and an electronic apparatus.

### BACKGROUND

Lithium-ion batteries have been widely used in the field of portable consumer electronics by virtue of their characteristics such as high specific energy, high working voltage, low self-discharge rate, small size, and light weight. With the rapid development of electric vehicles and mobile electronic devices in recent years, there are increasingly high requirements have been imposed on the cycling performance of lithium-ion batteries.

At present, with the increase of charge rate, the limitation on the migration speed of lithium ions results in an increasing internal polarization of lithium-ion batteries, affecting the rate performance and cycling performance of lithium-ion batteries.

### SUMMARY

An objective of this application is to provide a secondary battery and an electronic apparatus, to lower the impedance of the secondary battery, reduce the swelling of the negative electrode plate, and improve the rate performance and cycling performance of the secondary battery. Specific technical solutions are as follows.

It should be noted that in the invention of this application, the lithium-ion battery is used as an example of the secondary battery to illustrate this application. However, the secondary battery of this application is not limited to the lithium-ion battery.

A first aspect of this application provides a secondary battery. The secondary battery includes a negative electrode plate, where the negative electrode plate includes a negative electrode current collector and a negative electrode material layer disposed on at least one surface of the negative electrode current collector, and a cohesion of the negative electrode material layer is Z N/m, where 15≤Z≤45, preferably 19.4≤Z≤29.9; and the negative electrode material layer includes a negative electrode active material, a solid electrolyte material, and a negative electrode binder, the solid electrolyte material contains lanthanum, and based on a mass of the negative electrode material layer, a mass percentage of lanthanum is a, where 0.16%≤a≤5%, preferably 0.166%≤a≤1.965%. The solid electrolyte material in the negative electrode material layer can improve the ionic conductance of the negative electrode plate and lower the impedance of the secondary battery. Lanthanum in the solid electrolyte material has a catalytic effect on the electrolyte solution. With the percentage of lanthanum being controlled within the range in this application, the electrolyte solution can be further polymerized, and the bonding between the solid electrolyte material and the negative electrode active material is enhanced, increasing the cohesion of the negative electrode material layer and reducing the swelling rate of the negative electrode plate during cycling. With the foregoing settings, the secondary battery has good rate performance and cycling performance.

In an embodiment of this application, 5.5×10⁻⁵≤a/Z≤1.5×10⁻³, preferably 2.5×10⁻⁴≤a/Z≤6×10⁻⁴. With the value of a/Z being controlled within the foregoing range, it is conducive to ensuring that the negative electrode material layer has high cohesion while lowering the impedance of the secondary battery, thereby reducing the swelling rate of the negative electrode plate during cycling. Therefore, the secondary battery has good rate performance and cycling performance.

In an embodiment of this application, the solid electrolyte material includes Li₃ₓLa_{2/3-x}TiO₃, where 0.1≤x≤0.3. With the use of the foregoing type of solid electrolyte, it is conducive to accelerating the conduction of lithium ions within the negative electrode plate, thereby lowering the impedance of the secondary battery and enhancing the rate performance of the secondary battery. In addition, lanthanum and titanium in the solid electrolyte material have a catalytic effect on the electrolyte solution so that the electrolyte solution can be further polymerized, and the bonding between the solid electrolyte material and the negative electrode active material is enhanced, thereby increasing the cohesion of the negative electrode material layer and reducing the swelling rate of the negative electrode plate during cycling. Therefore, the secondary battery has good rate performance and cycling performance.

In an embodiment of this application, the solid electrolyte material further includes Li_{1+y}Al_{y}Ti_{2-y}(PO₄)₃, where 0<y≤0.5. With the use of the foregoing types of solid electrolytes, it is conducive to accelerating the conduction of lithium ions within the negative electrode plate, thereby lowering the impedance of the secondary battery and improving the rate performance of the secondary battery. In addition, the solid electrolyte material added can reduce contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance.

In an embodiment of this application, the solid electrolyte material includes titanium, and based on the mass of negative electrode material layer, a mass percentage of titanium is b, where 0.08%≤b≤3%. The combination of titanium and lanthanum in the solid electrolyte material exhibits a synergistic catalytic effect. With the mass percentage of titanium being controlled within the range in this application, the electrolyte solution can be further polymerized, and the bonding between the solid electrolyte material and the negative electrode active material is enhanced, thereby increasing the cohesion of the negative electrode material layer and reducing the swelling rate of the negative electrode plate during cycling while lowering the impedance of the secondary battery. Therefore, the secondary battery has good rate performance and cycling performance.

In an embodiment of this application, a region located on outer part of a particle of the negative electrode active material and within 2 μm from the surface of the particle of the negative electrode active material is an external region, the external region including lanthanum and titanium; and based on the mass of the negative electrode material layer, a mass percentage of lanthanum in the external region is a1, where 0.12%≤a1≤4%, preferably 0.12%≤a1≤1.2%, and a mass percentage of titanium in the external region is b1, where 0.08%≤b1≤1.2%, preferably 0.08%≤b1≤0.9%. The mass percentages of titanium and lanthanum in the external region being controlled within the foregoing ranges indicate that the presence of a portion of the solid electrolyte material on the surface of the negative electrode active material particles is conducive to increasing the synergistic catalytic efficiency of titanium and lanthanum. The electrolyte solution further undergoes in-situ polymerization reactions, and the bonding between the solid electrolyte material and the negative electrode active material is enhanced, thereby increasing the cohesion of the negative electrode material layer and reducing the swelling rate of the negative electrode plate during cycling while lowering the impedance of the secondary battery. Therefore, the secondary battery has good rate performance and cycling performance.

In an embodiment of this application, the electrolyte solution includes a compound A, where the compound A includes at least one selected from the group consisting of fluoroethylene carbonate, vinylene carbonate, and vinyl ethylene carbonate; and based on a mass of the electrolyte solution, a mass percentage of the compound A is X, where 3.5%≤X≤13.5%, and 0.67≤X/(a1+b1)≤67.5. With the addition of compound A to the electrolyte solution and the mass percentage of compound A being controlled within the foregoing range, the electrolyte solution contains carbon-oxygen double bonds, and lanthanum in the solid electrolyte material catalyzes polymerization. The carbon-oxygen double bonds further increase the degree of polymerization, and this is conducive to increasing the catalytic efficiency of lanthanum in the solid electrolyte material and enhancing the bonding between the solid electrolyte material and the negative electrode active material, thereby increasing the cohesion of the negative electrode material layer and reducing the swelling rate of the negative electrode plate during cycling while lowering the impedance of the secondary battery. Therefore, the secondary battery has good rate performance and cycling performance.

In an embodiment of this application, the electrolyte solution includes a compound B, where the compound B includes at least one selected from the group consisting of propylene sulfite, 1,3-propane sultone, and ethylene sulfate; and based on the mass of the electrolyte solution, a mass percentage of the compound B is Y, where 1.2%≤Y≤6.5%, and 1.25≤Y/(a1+b1)≤32.5. With the addition of compound B to the electrolyte solution and the mass percentage of compound B being controlled within the foregoing range, the electrolyte solution contains carbon-oxygen double bonds, and lanthanum in the solid electrolyte material catalyzes polymerization. The carbon-oxygen double bonds further increase the degree of polymerization, and this is conducive to increasing the catalytic efficiency of lanthanum in the solid electrolyte material and enhancing the bonding between the solid electrolyte material and the negative electrode active material, thereby increasing the cohesion of the negative electrode material layer and reducing the swelling rate of the negative electrode plate during cycling while lowering the impedance of the secondary battery. Therefore, the secondary battery has good rate performance and cycling performance.

In an embodiment of this application, the negative electrode material layer includes a negative electrode binder, and the negative electrode binder includes at least one selected from the group consisting of polyacrylate, polyimide, polyamide, polyamideimide, polyvinylidene fluoride, styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, and potassium hydroxymethyl cellulose; and based on the mass of the negative electrode material layer, a mass percentage of the negative electrode binder is 1.8% to 9.8%. With the use of foregoing type of negative electrode binder and the mass percentage of the negative electrode binder being controlled within the foregoing range, the negative electrode material layer has high cohesion, thereby reducing the swelling of the negative electrode plate. Therefore, the secondary battery has good rate performance and cycling performance.

A second aspect of this application provides an electronic apparatus including the secondary battery according to any one of the foregoing embodiments. The secondary battery provided in this application has good rate performance and cycling performance, so the electronic apparatus of this application has a long service life.

This application has the following beneficial effects:

This application provides a secondary battery and an electronic apparatus. The secondary battery includes a negative electrode plate, where the negative electrode plate includes a negative electrode material layer, and a cohesion of the negative electrode material layer is Z N/m, where 15≤Z≤45; and the negative electrode material layer includes a negative electrode active material and a solid electrolyte material, the solid electrolyte material includes lanthanum, and based on a mass of the negative electrode material layer, a mass percentage of lanthanum is a, where 0.16%≤ a≤5%. The solid electrolyte material in the negative electrode material layer can improve the ionic conductance and electronic conductance of the negative electrode plate and lower the impedance of the secondary battery. Lanthanum in the solid electrolyte material has a catalytic effect on the electrolyte solution. With the percentage of lanthanum being controlled within the range in this application, the electrolyte solution can be further polymerized, and the bonding between the solid electrolyte material and the negative electrode active material is enhanced, increasing the cohesion of the negative electrode material layer and reducing the swelling rate of the negative electrode plate during cycling. With the foregoing settings, the secondary battery has good rate performance and cycling performance.

Certainly, when any product or method of this application is implemented, all advantages described above are not necessarily demonstrated simultaneously.

### BRIEF DESCRIPTION OF DRAWINGS

To describe the technical solutions in some embodiments of this application or in the prior art more clearly, the following briefly describes the accompanying drawings required for describing these embodiments or the prior art. Apparently, the accompanying drawings in the following descriptions show merely some embodiments of this application, and persons of ordinary skill in the art may still derive other embodiments from these accompanying drawings.

FIG. 1 is a schematic diagram showing partial positional relationship of negative electrode active material particles in relation to solid electrolyte particles according to an embodiment this application;

FIG. 2 is a scanning electron microscope image of Comparative example 1 of this application at a magnification of 1000;

FIG. 3 is a scanning electron microscope image of Comparative example 1 of this application at a magnification of 5000;

FIG. 4 is a scanning electron microscope image of Example 1-1 of this application at a magnification of 1000;

FIG. 5 is a scanning electron microscope image of Example 1-1 of this application at a magnification of 5000;

FIG. 6 is a surface mapping image of element silicon in a cross-section of a negative electrode plate of Example 1-1 of this application;

FIG. 7 is a surface mapping image of element carbon in a cross-section of a negative electrode plate of Example 1-1 of this application;

FIG. 8 is a surface mapping image of element lanthanum in a cross-section of a negative electrode plate of Example 1-1 of this application;

FIG. 9 is a surface mapping image of element titanium in a cross-section of a negative electrode plate of Example 1-1 of this application;

FIG. 10 is a line mapping image of energy spectrum analysis of Example 1-1 of this application; and

FIG. 11 is a comparison diagram of cycling performance between Example 1-1 and Comparative example 3 of this application.

Reference signs: negative electrode active material 11; solid electrolyte 12; and external region 101.

### DETAILED DESCRIPTION

The following clearly and completely describes the technical solutions in some embodiments of this application with reference to the accompanying drawings in some embodiments of this application. Apparently, the described embodiments are only some rather than all of these embodiments of this application. All other embodiments obtained by persons skilled in the art based on this application shall fall within the protection scope of this application.

It should be noted that in the invention of this application, the lithium-ion battery is used as an example of the secondary battery to illustrate this application. However, the secondary battery of this application is not limited to the lithium-ion battery.

Currently, in the prior art, the kinetic performance of the lithium-ion battery is generally improved by optimization of electrolyte solution, surface treatment of a positive electrode active material and/or a negative electrode active material, and porous treatment of positive electrode plate and/or negative electrode plate, but the operation process is complicated and costly, and in addition, the porous treatment of positive electrode plate and/or negative electrode plate also causes a loss of energy density of the lithium-ion battery. In view of this, this application provides a secondary battery and an electronic apparatus, to lower the impedance of the secondary battery and improve the rate performance and cycling performance of the secondary battery.

A first aspect of this application provides a secondary battery. The secondary battery includes a negative electrode plate, where the negative electrode plate includes a negative electrode current collector and a negative electrode material layer disposed on at least one surface of the negative electrode current collector, and a cohesion of the negative electrode material layer is Z N/m, where 15≤Z≤45, preferably 19.4≤Z≤ 29.9. For example, Z may be 15, 16, 17, 18, 19, 19.5, 20, 23, 25, 27, 29, 30, 33, 35, 38, 40, 43, or 45, or a range defined by any two of the foregoing values. The negative electrode material layer includes a negative electrode active material, a solid electrolyte material, and a negative electrode binder. At least a portion of the solid electrolyte material is present on the surface of the negative electrode active material, and a portion of the solid electrolyte material is present between particle pores of the negative electrode active material. The solid electrolyte material contains lanthanum, and based on a mass of the negative electrode material layer, a mass percentage of lanthanum is a, where 0.16%≤a≤5%, preferably, 0.166%≤a≤1.965%. For example, a may be 0.16%, 0.163%, 0.165%, 0.166%, 0.17%, 0.2%, 0.25%, 0.3%, 0.5%, 0.8%, 1%, 1.3%, 1.7%, 1.8%, 1.9%, 1.93%, 1.95%, 0.1.96%, 1.963%, 1.965%, 1.967%, 1.97%, 2%, 2.3%, 2.7%, 3%, 3.3%, 3.8%, 4%, 4.2%, 4.7%, or 5%, or a range defined by any two of the foregoing values.

The solid electrolyte material added in the negative electrode material layer can enhance the ionic conductivity of the negative electrode plate and lower the impedance of the secondary battery. However, compared with the negative electrode active material particles, the solid electrolyte material particles are smaller and have a larger specific surface area. The negative electrode binder is prone to being accumulated on the surface of the solid electrolyte material, leading to insufficient adhesion force between the negative electrode active material particles. As the amount of the solid electrolyte material added increases, the foregoing problems become more prominent. As the cycling process of the secondary battery proceeds, possible factors such as floating of the negative electrode binder and swelling and breakage of the negative electrode active material can further reduce the adhesion force during the continuous deintercalation and intercalation. The inventors have found through research that the adjustment of the positional relationship of the solid electrolyte material particles in relation to the negative electrode active material particles can alleviate the foregoing problems to a large extent. The inventors have also found that lanthanum in the solid electrolyte material has a catalytic effect on the electrolyte solution. With the percentage of lanthanum being controlled within the range in this application, the electrolyte solution can be further polymerized, the bonding between the solid electrolyte material and the negative electrode active material is enhanced, and at least a portion of the solid electrolyte material particles are present on the surface of the negative electrode active material, thereby increasing the cohesion of the negative electrode material layer and reducing the swelling rate of the negative electrode plate during cycling. In this application, with the mass percentage of lanthanum and the cohesion of the negative electrode material layer being controlled within the foregoing ranges, the impedance of the secondary battery can be lowered, the swelling of the negative electrode plate is reduced, and the secondary battery has good rate performance and cycling performance. In this application, the percentage of lanthanum in the negative electrode material layer can be controlled by adjusting the type of the solid electrolyte material and the amount of the solid electrolyte material added to the negative electrode material layer.

In an embodiment of this application, 5.5×10⁻⁵° C. a/Z≤1.5×10⁻³, preferably 2.5×10⁻⁴≤a/Z≤6×10⁻⁴. For example, the value of a/Z may be 5.5×10⁻⁵, 8×10⁻⁵, 1×10⁻⁴, 2×10⁻⁴, 2.3×10⁻⁴, 2.5×10⁻⁴, 2.7×10⁻⁴, 3×10⁻⁴, 4×10⁻⁴, 5×10⁻⁴, 6×10⁻⁴, 7×10⁻⁴, 8×10⁻⁴, 1×10⁻³, 1.2×10⁻³, or 1.5×10⁻³, or a range defined by any two of the foregoing values. With the value of a/Z being controlled within the foregoing range, it is conducive to ensuring that the negative electrode material layer has high cohesion while lowering the impedance of the secondary battery, thereby reducing the swelling rate of the negative electrode plate during cycling. Therefore, the secondary battery has good rate performance and cycling performance.

In an embodiment of this application, a compacted density of the negative electrode plate is 1.7 g/cm³ to 1.9 g/cm³. For example, the compacted density of the negative electrode plate is 1.7 g/cm³, 1.75 g/cm³, 1.8 g/cm³, 1.85 g/cm³, or 1.9 g/cm³, or a range defined by any two of the foregoing values. With the compacted density of the negative electrode plate being controlled within the foregoing range, the compacted density of the negative electrode plate is high. The addition of a solid electrolyte material to the negative electrode material layer is conducive to enhancing the ionic conductivity of the negative electrode plate, lowering the impedance of the secondary battery, and allowing tighter bonding between the negative electrode active material particles and the solid electrolyte material, thereby increasing the cohesion of the negative electrode material layer and reducing the swelling rate of the negative electrode plate during cycling. Therefore, the secondary battery has good rate performance and cycling performance.

In an embodiment of this application, the solid electrolyte material includes Li₃ₓLa_{2/3-x}TiO₃, where 0.1≤x≤0.3. For example, x may be 0.1, 0.13, 0.15, 0.17, 0.2, 0.22, 0.25, 0.27, or 0.3, or a range defined by any two of the foregoing values, and the solid electrolyte material may be Li_{0.3}La_{0.57}TiO₃, Li_{0.39}La_{0.54}TiO₃, Li_{0.45}La_{0.52} TiO₃, Li_{0.51}La_{0.5}TiO₃, Li_{0.6}La_{0.47}TiO₃, Li_{0.66}La_{0.45} TiO₃, Li_{0.75}La_{0.42} TiO₃, Li_{0.81}La_{0.4}TiO₃, or Li_{0.9} La_{0.37}TiO₃. With the use of the foregoing types of solid electrolytes, in the negative electrode material layer, the ionic conductance of the negative electrode plate can be enhanced while balancing the electronic conductance of the negative electrode plate, and this is conducive to accelerating the conduction of lithium ions within the negative electrode plate, thereby lowering the impedance of the secondary battery and improving the rate performance of the secondary battery. In addition, lanthanum and titanium in the solid electrolyte material have a catalytic effect on the electrolyte solution so that the electrolyte solution can be further polymerized, the bonding between the solid electrolyte material and the negative electrode active material is enhanced, and at least a portion of the solid electrolyte material particles are present on the surface of the negative electrode active material particles, thereby increasing the cohesion of the negative electrode material layer and reducing the swelling rate of the negative electrode plate during cycling. Therefore, the secondary battery has good rate performance and cycling performance. In this application, based on the mass of the negative electrode material layer, a mass percentage M of the solid electrolyte material Li₃ₓLa_{2/3-x}TiO₃ is 0.1% to 10%.

In an embodiment of this application, the solid electrolyte material further includes Li_{1+y}Al_{y}Ti_{2-y}(PO₄)₃, where 0<y≤0.5. For example, y is 0.1, 0.2, 0.3, 0.4, or 0.5, or a range defined by any two of the foregoing values, and the solid electrolyte material may be Li_{1.1}Al_{0.1}Ti_{1.9}(PO₄)₃, Li_{1.2}Al_{1.2}Ti_{1.8}(PO₄)₃, Li_{1.3}Al_{0.3}Ti_{1.7}(PO₄)₃, Li_{1.4}Al_{0.4}Ti_{1.6}(PO₄)₃, or Li_{1.5}Al_{0.5}Ti_{1.5}(PO₄)₃. With the use of the foregoing types of solid electrolytes, in the negative electrode material layer, the ionic conductance of the negative electrode plate can be enhanced while balancing the electronic conductance of the negative electrode plate, and this is conducive to accelerating the conduction of lithium ions within the negative electrode plate, thereby lowering the impedance of the secondary battery and improving the rate performance of the secondary battery. In addition, the solid electrolyte material added can reduce contact between the negative electrode active material and the electrolyte solution, thereby reducing side reactions between the electrolyte solution and the negative electrode active material and improving the lithium precipitation performance of the secondary battery. Therefore, the secondary battery has good rate performance, lithium precipitation performance, and cycling performance. In this application, based on the mass of the negative electrode material layer, a mass percentage N of the solid electrolyte material Li_{1+y}Al_{y}Ti_{2-y}(PO₄)₃ is 0.2% to 9.8%.

In an embodiment of this application, the solid electrolyte material includes titanium, and based on the mass of negative electrode material layer, a mass percentage of titanium is b, where 0.08%≤b≤3%. For example, b may be 0.08%, 0.1%, 0.5%, 0.8%, 1%, 1.3%, 1.5%, 1.8%, 2%, 2.3%, 2.5%, 2.7%, 3%, or a range between any two of these values. The combination of titanium and lanthanum in the solid electrolyte material exhibits a synergistic catalytic effect. With the mass percentage of titanium being controlled within the range in this application, the electrolyte solution can be further polymerized, the bonding between the solid electrolyte material and the negative electrode active material is enhanced, and at least a portion of the solid electrolyte material particles are present on the surface of the negative electrode active material particles, thereby increasing the cohesion of the negative electrode material layer and reducing the swelling rate of the negative electrode plate during cycling while lowering the impedance of the secondary battery. Therefore, the secondary battery has good rate performance and cycling performance. In this application, the percentage of titanium in the negative electrode material layer can be adjusted by adjusting the type of the solid electrolyte material and the amount of the solid electrolyte material added to the negative electrode material layer.

In an embodiment of this application, at least a portion of the solid electrolyte material particles are present on the surface of the negative electrode active material particles. As shown in FIG. 1, a region located on outer part of particles of the negative electrode active material 11 and within 2 μm from the surface of the particles of the negative electrode active material 11 is an external region 101; line mapping is performed on the external region 101; the external region 101 contains lanthanum and titanium; and based on the mass of the negative electrode material layer, a mass percentage of lanthanum in the external region 101 is a1, where 0.12%≤a1≤4%, preferably 0.12%≤a1≤1.2%. For example, a1 may be 0.12%, 0.2%, 0.5%, 0.8%, 1%, 1.2%, 1.6%, 2%, 2.3%, 2.7%, 3%, 3.3%, 3.8%, 4%, or a range defined by any two of the foregoing values. A mass percentage of titanium in the external region 101 is b1, where 0.08%≤b1≤1.2%, preferably 0.08%≤b1≤0.9%. For example, b1 may be 0.08%, 0.1%, 0.3%, 0.5%, 0.7%, 0.9%, 1%, or 1.2%, or a range defined by any two of the foregoing values. The mass percentages of titanium and lanthanum in the external region being controlled within the foregoing ranges indicate that the presence of a portion of the solid electrolyte material on the surface of the negative electrode active material particles is conducive to increasing the synergistic catalytic efficiency of titanium and lanthanum. The electrolyte solution further undergoes in-situ polymerization reactions, and the bonding between the solid electrolyte material and the negative electrode active material is enhanced, thereby increasing the cohesion of the negative electrode material layer and reducing the swelling rate of the negative electrode plate during cycling while lowering the impedance of the secondary battery. Therefore, the secondary battery has good rate performance and cycling performance. The manner of controlling the percentages of lanthanum and titanium in the external region is not particularly limited in this application, provided that the objectives of this application can be achieved. For example, the negative electrode active material and the solid electrolyte material are mixed in advance and then a resulting dry powder is stirred, with a dry power stirring time of 30 minutes to 1 hour. In this application, different percentages of lanthanum and titanium in the external region can be obtained by adjusting the dry powder stirring time and the amount of the solid electrolyte material added. With a longer dry powder stirring time and a greater amount of the solid electrolyte material added, different higher percentages of lanthanum and titanium in the external region are obtained. With a shorter dry powder stirring time or no dry powder stirring and a smaller amount of the solid electrolyte material added, different lower percentages of lanthanum and titanium in the external region are obtained. The particle size of the negative electrode active material is not particularly limited in this application, provided that the objectives of this application are satisfied. For example, D_{V}50 of the negative electrode active material is 1 μm to 25 μm. The particle size of the solid electrolyte material is not particularly limited in this application, provided that the objectives of this application are satisfied. For example, D_{V}50 of the solid electrolyte material may be 100 nm to 500 nm.

In an embodiment of this application, the negative electrode material layer includes a negative electrode binder, and the negative electrode binder includes at least one selected from the group consisting of polyacrylate, polyimide, polyamide, polyamideimide, polyvinylidene fluoride, styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, and potassium hydroxymethyl cellulose; and based on the mass of the negative electrode material layer, the mass percentage R of the negative electrode binder is 1.8% to 9.8%. For example, the mass percentage R of the negative electrode binder may be 1.8%, 2%, 4%, 6%, 8%, 9%, 9.5%, or 9.8%, or a range defined by any two of foregoing values. With the use of foregoing type of negative electrode binder and the mass percentage of the negative electrode binder being controlled within the foregoing range, the negative electrode material layer has high cohesion, thereby reducing the swelling of the negative electrode plate. Therefore, the secondary battery has good rate performance and cycling performance.

In this application, the “negative electrode material layer disposed on at least one surface of the negative electrode current collector” means that the negative electrode material layer may be disposed on one surface or two surfaces of the negative electrode current collector in its thickness direction. It should be noted that the “surface” herein may be an entire region of the surface of the negative electrode current collector, or may be a partial region of the surface of the negative electrode current collector. This is not particularly limited in this application, provided that the objectives of this application can be achieved. The negative electrode current collector is not particularly limited in this application, provided that the objectives of this application can be achieved. For example, the negative electrode current collector may include copper foil, copper alloy foil, nickel foil, stainless steel foil, titanium foil, foam nickel, foam copper, or a composite current collector (such as a lithium-copper composite current collector, a carbon-copper composite current collector, a nickel-copper composite current collector, or a titanium-copper composite current collector). The thickness of the negative electrode current collector is not particularly limited in this application, provided that the objectives of this application can be achieved. For example, a thickness of the negative electrode current collector is 4 μm to 20 μm. The negative electrode material layer may further include a conductive agent and a dispersant. The type of the conductive agent in the negative electrode material layer is not particularly limited in this application, provided that the objectives of this application can be achieved. For example, the conductive agent may include but is not limited to at least one of conductive carbon black (Super P), carbon nanotubes (CNTs), carbon fibers, flake graphite, Ketjen black, graphene, metal materials, or conductive polymers. The carbon nanotubes may include but are not limited to single-walled carbon nanotubes and/or multi-walled carbon nanotubes. The carbon fiber may include but is not limited to vapor grown carbon fiber (VGCF) and/or carbon nanofiber. The metal material may include but is not limited to metal powder and/or metal fiber, and specifically, the metal may include but is not limited to at least one of copper, nickel, aluminum, or silver. The conductive polymers may include but are not limited to at least one of polyphenylene derivative, polyaniline, polythiophene, polyacetylene, or polypyrrole. The dispersant may include but is not limited to at least one of carboxymethyl cellulose or sodium carboxymethyl cellulose. The porosity of the negative electrode plate is not particularly limited in this application, provided that the objectives of this application can be satisfied. For example, the porosity of the negative electrode plate is 18% to 28%. The coating weight of the negative electrode material layer is not particularly limited in this application, provided that the objectives of this application can be satisfied. For example, a coating weight of the negative electrode material layer on a single surface is 6 mg/cm² to 25 mg/cm².

The preparation method of negative electrode plate is not particularly limited in this application, provided that the objectives of this application can be achieved. For example, the preparation method of negative electrode plate includes but is not limited to the following steps: (1) mixing a negative electrode active material with a solid electrolyte material to uniformity to obtain a mixture, then mixing the mixture with a negative electrode binder, a conductive agent, and a dispersant based on a specific mass ratio, adding a solvent, and then stirring them to uniformity to prepare a negative electrode slurry; (2) applying the negative electrode slurry to one surface of the negative electrode current collector, followed by drying to form a negative electrode material layer on one surface of the negative electrode current collector; (3) applying the negative electrode slurry to another surface of the negative electrode current collector, followed by drying to form a negative electrode material layer on each of two surfaces of the negative electrode current collector; and (4) carrying out cold-pressing and cutting to obtain a negative electrode plate. The mass ratio of a mixture of the negative electrode active material with the solid electrolyte material, the negative electrode binder, the conductive agent, and the dispersant is not particularly limited in this application, and those skilled in the art can make selection according to actual needs, provided that the objectives of this application can be achieved. The solvent in the negative electrode slurry is not particularly limited in this application, provided that the objectives of this application can be achieved. For example, the solvent may be deionized water. The drying time and temperature are not particularly limited in this application, provided that the objectives of this application can be achieved.

In an embodiment of this application, the electrolyte solution includes a compound A, where the compound A includes at least one of fluoroethylene carbonate, vinylene carbonate, or vinyl ethylene carbonate; and based on a mass of the electrolyte solution, a mass percentage of the compound A is X, where 3.5%≤X≤13.5%, and 0.67≤X/(a1+b1)≤67.5. For example, X may be 3.5%, 4%, 5%, 7%, 10%, 12%, 13%, or 13.5%, or a range defined by any two of the foregoing values; and X/(a1+b1) may be 0.67, 1, 1.5, 2, 5, 8, 10, 12, 15, 18, 20, 23, 25, 27, 30, 33, 35, 38, 40, 42, 45, 48, 50, 53, 55, 57, 60, 63, 65, 67, or 67.5, or a range defined by any two of the foregoing values With the addition of compound A to the electrolyte solution and the mass percentage of compound A being controlled within the foregoing range, the electrolyte solution contains carbon-oxygen double bonds, and lanthanum in the solid electrolyte material catalyzes polymerization. The carbon-oxygen double bonds further increase the degree of polymerization, and this is conducive to increasing the catalytic efficiency, further enhancing the polymerization effect of the electrolyte solution and enhancing the bonding between the solid electrolyte material and the negative electrode active material, thereby increasing the cohesion of the negative electrode material layer and reducing the swelling rate of the negative electrode plate during cycling while lowering the impedance of the secondary battery. Therefore, the secondary battery has good rate performance and cycling performance.

In an embodiment of this application, the electrolyte solution includes a compound B, where the compound B includes at least one of propylene sulfite, 1,3-propane sultone, or ethylene sulfate; and based on the mass of the electrolyte solution, a mass percentage of the compound B is Y, where 1.2%≤Y≤6.5%, and 1.25≤Y/(a1+b1)≤32.5. For example, Y may be 1.2%, 1.5%, 2%, 3%, 4%, 5%, 6%, or 6.5%, or a range defined by any two of the foregoing values; and Y/(a1+b1) may be 1.25, 1.5, 2, 5, 7, 9, 10, 12, 15, 17, 20, 22, 25, 27, 29, 30, 32, or 32.5, or a range defined by any two of the foregoing values With the addition of compound B to the electrolyte solution and the mass percentage of compound B being controlled within the foregoing range, the electrolyte solution contains sulfur-oxygen double bonds, and lanthanum in the solid electrolyte material catalyzes polymerization. The sulfur-oxygen double bonds further increase the degree of polymerization, and this is conducive to increasing the catalytic efficiency, further enhancing the polymerization effect of the electrolyte solution, and enhancing the bonding between the solid electrolyte material and the negative electrode active material, thereby increasing the cohesion of the negative electrode material layer and reducing the swelling rate of the negative electrode plate during cycling while lowering the impedance of the secondary battery. Therefore, the secondary battery has good rate performance and cycling performance.

In an embodiment of this application, the electrolyte solution further includes a lithium salt and a non-aqueous solvent in addition to the compound A and the compound B. The lithium salt may include at least one of LiPF₆, LiNO₃, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium difluoroacetate borate (LiDFOB), lithium bistrifluoromethanesulfonimide (LiTFSI), or lithium difluoroborate. Based the mass of the electrolyte solution, a mass percentage of the lithium salt is 8% to 15%. The non-aqueous solvent is not particularly limited in this application, provided that the objectives of this application can be achieved. For example, the non-aqueous solvent may include but is not limited to at least one of carbonate compounds, carboxylate compounds, ether compounds, or other organic solvents. The carbonate compounds may include but are not limited to at least one of linear carbonate compounds, cyclic carbonate compounds, or fluorocarbonate compounds. The linear carbonate compounds may include but are not limited to at least one of dimethyl carbonate, diethyl carbonate, dipropyl carbonate, methyl propyl carbonate, ethylene propyl carbonate, or methyl ethyl carbonate. The cyclic carbonates may include but are not limited to at least one of ethylene carbonate, propylene carbonate (PC), or butylene carbonate. The fluorocarbonate compounds may be but are not limited to at least one of 1,2-difluoroethylene carbonate, 1,1-difluoroethylene carbonate, 1,1,2-tricarbonate fluoroethylene, 1,1,2,2-tetrafluoroethylene carbonate, 1-fluoro-2-methylethylene carbonate, 1-fluoro-1-methylethylene carbonate, carbonic acid 1,2-Difluoro-1-methylethylene, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compounds may include but are not limited to at least one of dibutyl ether, tetraethylene glycol dimethyl ether, diglyme, 1,2-dimethoxyethane, 1,2-diethoxyethane, 1-ethoxy-1-methoxyethane, 2-methyltetrahydrofuran, or tetrahydrofuran. The another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The mass percentage of the non-aqueous solvent is not particularly limited in this application, provided that the objectives of this application can be achieved. For example, based on the mass of the electrolyte solution, a mass percentage of the non-aqueous solvent is 65% to 92%.

In an embodiment of this application, the electrolyte solution may include a lithium salt and a non-aqueous solvent, the mass percentage of the lithium salt is as described above, and the mass percentage of the non-aqueous solvent is 85% to 92%. The secondary battery including the foregoing electrolyte solution has good rate performance and cycling performance.

In an embodiment of this application, the electrolyte solution may include a lithium salt, a compound A, and a non-aqueous solvent, the mass percentages of the lithium salt and the compound A are as described above, and the mass percentage of the non-aqueous solvent is 71.5% to 88.5%. The secondary battery including the foregoing electrolyte solution has good rate performance and cycling performance.

In an embodiment of this application, the electrolyte solution may include a lithium salt, a compound B, and a non-aqueous solvent, the mass percentages of the lithium salt and the compound B are as described above, and the mass percentage of the non-aqueous solvent is 78.5% to 90.8%. The secondary battery including the foregoing electrolyte solution has good rate performance and cycling performance.

In an embodiment of this application, the electrolyte solution may include a lithium salt, a compound A, a compound B, and a non-aqueous solvent, the mass percentages of the lithium salt, the compound A, and the compound B are as described above, and the mass percentage of the non-aqueous solvent is 65% to 87.3%. The secondary battery including the foregoing electrolyte solution has good rate performance and cycling performance.

In this application, the secondary battery includes a positive electrode plate. The positive electrode plate is not particularly limited in this application, provided that the objectives of this application can be achieved. For example, the positive electrode plate includes a positive electrode current collector and a positive electrode material layer disposed on at least one surface of the positive electrode current collector. The “positive electrode material layer disposed on at least one surface of the positive electrode current collector” means that the positive electrode material layer may be disposed on one surface of the positive electrode current collector in its thickness direction, or on two surfaces of the positive electrode current collector in its thickness direction. It should be noted that the “surface” herein may be an entire region or a partial region of the surface of the positive electrode current collector. This is not particularly limited in this application, provided that the objectives of this application can be achieved. The positive electrode current collector is not particularly limited in this application, provided that the objectives of this application can be achieved. For example, the positive electrode current collector may include aluminum foil, aluminum alloy foil, a composite current collector (such as an aluminum-carbon composite current collector), or the like. The positive electrode material layer of this application includes a positive electrode active material. The type of the positive electrode active material is not particularly limited in this application, provided that the objectives of this application can be achieved. For example, the positive electrode active material may include at least one of lithium nickel cobalt manganate (NCM811, NCM622, NCM523, NCM111), lithium nickel cobalt aluminate, lithium iron phosphate, lithium-rich manganese-based material, lithium cobalt oxide (LiCoO₂), lithium manganate, lithium iron manganese phosphate, lithium titanate, or the like. In this application, the positive electrode active material may further include a non-metal element. For example, the non-metal element includes at least one of fluorine, phosphorus, boron, chlorine, silicon, or sulfur. Thicknesses of the positive electrode current collector and the positive electrode material layer are not particularly limited in this application, provided that the objectives of this application can be achieved. For example, the thickness of the positive electrode current collector is 5 μm to 20 μm, preferably 6 μm to 18 μm. The thickness of the positive electrode active material layer on one surface ranges from 30 μm to 120 μm. In this application, the positive electrode material layer may further include a conductive agent and a positive electrode binder. The type of the positive electrode binder in the positive electrode material layer is not particularly limited in this application, provided that the objectives of this application can be achieved. For example, the positive electrode binder may be of the same type as the negative electrode binder in the negative electrode material layer described above. The type of the conductive agent in the positive electrode material layer is not particularly limited in this application, provided that the objectives of this application can be achieved. For example, the conductive agent may be of the same type as the conductive agent in the negative electrode material layer described above. A mass ratio of the positive electrode active material, the conductive agent, and the positive electrode binder in the positive electrode material layer is not particularly limited in this application, and persons skilled in the art can make selection based on actual needs, provided that the objectives of this application can be achieved.

The separator is not particularly limited in this application, provided that the objectives of this application can be achieved. For example, the material of the separator may include but is not limited to at least one of polyolefin (PO) such as polyethylene (PE) or polypropylene (PP), polyester (for example, polyethylene terephthalate (PET) film), cellulose, polyimide (PI), polyamide (PA), spandex, or aramid. The type of the separator may include at least one of a woven film, a nonwoven film, a microporous film, a composite film, a rolling film, or a spinning film. The separator of this application can have a porous structure, and the pore size of the porous structure of the separator is not particularly limited in this application, provided that the of objectives porous structure of this application can be achieved. For example, the pore size may be 0.01 μm to 1 μm. The thickness of the separator is not particularly limited this application, provided that the objectives of this application can be achieved. For example, the thickness of the separator may be 5 μm to 50 μm.

The secondary battery of this application further includes a packaging bag for accommodating the positive electrode plate, the negative electrode plate, the separator, the electrolyte solution, and other known components of the secondary battery in the art. The other components are not limited in this application. The packaging bag is not particularly limited in this application and may be any well-known packaging bag in the art, provided that the objectives of this application can be achieved.

The secondary battery in this application is not particularly limited and may include any apparatus in which electrochemical reactions take place. In an embodiment of this application embodiments, the secondary battery may include but is not limited to a lithium-ion secondary battery (a lithium-ion battery), a lithium polymer secondary battery, or a lithium-ion polymer secondary battery.

The preparation method of secondary battery is not particularly limited in this application, and any well-known preparation method in the art can be used, provided that the objectives of this application can be achieved. For example, the preparation method of secondary battery includes but is not limited to the following steps: stacking a positive electrode plate, a separator, and a negative electrode plate in sequence, performing operations such as winding and folding on the stack as needed to obtain an electrode assembly with a wound structure, placing the electrode assembly into a packaging bag, injecting an electrolyte solution into the packaging bag and sealing the packaging bag to obtain a secondary battery; or stacking a positive electrode plate, a separator, and a negative electrode plate in sequence, fixing four corners of an entire stacked structure to obtain an electrode assembly with a stacked structure, placing the electrode assembly into a packaging bag, injecting an electrolyte solution into the packaging bag and sealing the packaging bag to obtain a secondary battery.

A second aspect of this application provides an electronic apparatus including the secondary battery according to any one of the foregoing embodiments. The secondary battery provided in this application has good rate performance and cycling performance, so the electronic apparatus of this application has a longer service life.

The electronic apparatus of this application is not particularly limited, and the electronic apparatus may be any known electronic apparatus used in the prior art. For example, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a storage card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, and a lithium-ion capacitor.

### Example

In the following, examples and comparative examples are given to describe some embodiments of this application in more detail. Various tests and evaluations are performed in the following methods.

### Test Methods and Devices

### Method for Sampling Negative Electrode Plate and Negative Electrode Active Material

At an ambient temperature of 25° C., a lithium-ion battery was disassembled to take out a negative electrode plate, the negative electrode plate was soaked in dimethyl carbonate (DMC) for 20 minutes, and then the negative electrode plate was placed into an oven and dried at 80° C. for 12 hours to obtain a negative electrode plate sample. The sampling method described above was used for all negative electrode plate samples in the following tests: test for mass percentage of lanthanum and titanium, test for mass percentage of lanthanum and titanium in external region, scanning electron microscopy test, and test for cohesion of negative electrode material layer.

### Test for Mass Percentages of Lanthanum and Titanium

Ion polishing was performed on the negative electrode plate sample to obtain a cross-section of the negative electrode plate sample. An X-ray energy dispersive spectrometer (EDS) was used for element analysis test, surface mapping (mapping) and line mapping tests were performed on a cross-section of the negative electrode plate sample. For the line mapping test, reference may be made to a schematic test diagram of FIG. 10. Specifically, in FIG. 10, the horizontal coordinates in (b) to (d) represent the cross-sectional test distance of the negative electrode plate sample, with the starting and ending points corresponding to line segment Q in (a) of FIG. 10. Based on the EDS mapping test, cross-sectional element distribution of the negative electrode plate sample can be observed. Based on the EDS line mapping results, the change in the percentage of element at each point on line segment Q can be observed.

The negative electrode material layer was scrapped from the negative electrode current collector of the negative electrode sample to obtain a powder sample. 0.1 g of the powder sample was weighed and placed into a digestion tank; 10 mL of aqua regia digestion reagent was added into the tank; the tank was shaken for 30 minutes for digestion; the sample digested was poured into a volumetric flask and diluted to 150 mL with deionized water; and an inductively coupled plasma optical emission spectrometer (ICP-OES, model Agilent 5800) was used to test the sample against a standard sample according to the US Environmental Protection Agency (EPA) standards EPA 3052-1996 and EPS 6010D-2014 to obtain concentrations of lanthanum and titanium. The mass percentage of lanthanum in the negative electrode material layer is a %, a %=(concentration of lanthanum×constant volume)/mass of powder sample×100%. The mass percentage of titanium in the negative electrode material layer is b %, b %=(concentration of titanium×constant volume)/mass of powder sample×100%.

### Test for Mass Percentages of Lanthanum and Titanium in External Region

A scanning electron microscopy and energy-dispersive X-ray fluorescence spectrometer (SEM-EDX) was used for element analysis test on the negative electrode plate. A negative electrode active material with single particles was selected. As shown in FIG. 1, line mapping was performed on the external region 101 located on outer part of a particle of the negative electrode active material 11 and within 2 μm from the surface of the negative electrode active material 11 with single particles. Five directions were randomly selected for mapping, average values were taken from mass percentages of lanthanum and mass percentages of titanium in the external region obtained in the five directions, and to be specific, they are the mass percentage a1 of lanthanum and the mass percentage b1 of titanium in the external region.

### Scanning Electron Microscopy Test

Ion polishing was performed on the negative electrode plate sample to obtain a cross-section of the negative electrode plate sample. A Philips XL-30 field emission scanning electron microscope was used for testing under the conditions of 10 kV and 10 mA. Silicon particles and graphite particles were distinguished and counted using a backscatter mode. The silicon particle regions were brighter, and the graphite particle regions were darker.

### Test for Cohesion of Negative Electrode Material Layer

The test for cohesion of the negative electrode material layer was performed through a tensile test. A mold was used to punch samples of the negative electrode plate to obtain test strips with a length of 80 mm and a width of 20 mm. The surface of a stainless steel plate was cleaned with alcohol, then a pressure-sensitive adhesive tape with a length of 60 mm and a width of 20 mm was pasted onto the stainless steel plate without generating bubbles during pasting. The test strip was pasted on the pressure-sensitive adhesive tape with the test surface facing up. A green tape (with a width of 20 mm and a length of 80 mm) was centrally pasted on the test strip, and a paper strip with a length of 60 mm and a width of 20 mm was cut and inserted into a gap between the test strip and the green tape, with a cross overlap length of 15 mm. A 2 kg rubber roller was used to manually roll back and forth on the test strip four times to obtain a test sample. A tensile machine was used to test the test sample. The test sample was fixed on a test bench, then folded 180° upwards and fixed with a clamp. The tensile machine then slowly pulled the paper strip at a speed of 10 mm/min until the green tape was separated from the negative electrode material layer on the surface of the negative electrode plate, and then the test ended. An average value of the tensile force in stable region was taken and recorded as the cohesion of the negative electrode material layer, with the unit of N/m.

### Swelling Rate Test

At an ambient temperature of 25° C., an initial thickness of the lithium-ion battery was measured using a micrometer. The lithium-ion battery was charged to 4.45 V at a constant current of 0.7 C, charged to 0.025 C at a constant voltage of 4.45 V, left standing for 5 minutes, and discharged to 3.0 V at 0.5 C. After 500 cycles of the charging and discharging process, a thickness of the lithium-ion battery in this case was measured using the micrometer again.

Swelling rate of lithium-ion battery (%)=(thickness of lithium-ion battery after 500 cycles−initial thickness of lithium-ion battery)/initial thickness of lithium-ion battery×100%.

### Test for Impedance of Lithium-Ion Battery

An electrochemical workstation Solartron 1260A was used to test the impedance of lithium-ion batteries in examples and comparative examples. The electrochemical impedance spectroscopy (EIS) of the lithium-ion battery was tested within a frequency range of 5 Mhz to 1000 kHz, with a perturbation voltage of 5 mV and a test temperature of 25° C., to obtain the impedance of the lithium-ion battery.

### Cycling Performance Test

At a test temperature of 25° C., lithium-ion batteries in the examples and comparative examples were charged to 4.45 V at a constant current of 0.7 C, and then charge to 0.025 C at a constant voltage of 4.45 V, left standing for 5 minutes, and discharged to 3.0 V at 0.5 C. The capacity obtained in this step was the initial capacity. The cycling test was performed according to the foregoing cycling process, the capacity of the lithium-ion battery was measured after each cycle, and with a ratio of the capacity of each cycle to the initial capacity, a capacity decay curve was obtained. A first discharge capacity was expressed as 100%, the charge and discharge cycle was repeated until the capacity retention rate decayed to 80% of the first discharge capacity, then the test stopped, and the number of cycles was recorded.

### Rate Performance Test

At an ambient temperature of 25° C., the lithium-ion batteries in the examples and comparative examples were charged to 4.45 V at a constant current of 0.7 C, and then charged to 0.025 C at a constant voltage of 4.45 V, left standing for 5 minutes, then discharged to 3 V at 0.5 C, and a discharge capacity at 0.7 C was recorded. The lithium-ion batteries were left standing for 5 minutes, then charged again to 4.45 V at a constant current of 0.5 C, and charged at a constant voltage of 4.45 V until the current is 0.025 C, left standing for 5 minutes, then discharged to 3 V at 3 C, and a discharge capacity at 3 C was recorded. Discharge capacity retention rate at 3 C (%)=discharge capacity at 3 C/discharge capacity at 0.7 C×100%.

### Example 1-1

### <Preparation of Negative Electrode Plate>

A negative electrode active material was mixed with solid electrolyte Li_{0.3}La_{0.567}TiO₃ and then a resulting dry powder was stirred, with a stirring time of 30 minutes. Then, a mixture of the negative electrode active material and the solid electrolyte material, negative electrode binder styrene-butadiene rubber, conductive agent conductive carbon black, and dispersant sodium carboxymethyl cellulose were mixed at a mass ratio of 96:3:0.5:0.5, added with deionized water as a solvent, and stirred to uniformity to obtain a negative electrode slurry with a solid content of 70 wt %. The negative electrode slurry was uniformly applied on one surface of a negative electrode current collector copper foil with a thickness of 6 μm and dried at 120° C., to obtain a negative electrode plate having a negative electrode material layer coated on a single surface with a coating weight CW of 8 mg/cm². Then the foregoing operation steps were repeated on the other surface of the negative electrode current collector copper foil to obtain a negative electrode plate having a negative electrode material layer coated on two surfaces. The coated negative electrode plate was cold-pressed to obtain a negative electrode plate with a compacted density of 1.75 g/cm³. Then the negative electrode plate was cut in dimensions of 74 mm×800 mm for later use. The negative electrode active material was a mixture of artificial graphite and silicon, and a mass ratio of artificial graphite and silicon was 1:1. Based on the mass of the negative electrode material layer, the mass percentage M of the solid electrolyte material Li_{0.3}La_{0.567}TiO₃ was 2%, the mass percentage R of the negative electrode binder was 3%, the mass percentage a of lanthanum was 0.890%, and the mass percentage b of titanium was 0.543%.

### <Preparation of Positive Electrode Plate>

Positive electrode active substance lithium cobaltate (LiCoO₂), conductive agent Super P, and binder polyvinylidene fluoride (PVDF) at a mass ratio of 97:1.4:1.6 were dispersed in solvent N-methylpyrrolidone (NMP) and fully stirred and mixed to obtain a positive electrode slurry with a solid content of 72 wt %. The positive electrode slurry was uniformly applied onto one surface of a positive electrode current collector aluminum foil with a thickness of 8 μm and dried at 85° C. to obtain a positive electrode plate having a positive electrode material layer coated on a single surface with a coating weight of 12 mg/cm². Then, the foregoing steps were repeated on another surface of the positive electrode current collector aluminum foil to obtain a positive electrode plate having the positive electrode material layer coated on two surfaces. After cold pressing, cutting, and slitting, drying was performed in vacuum at 85° C. for 4 hours to obtain positive electrode plates with a dimension of 72 mm×792 mm for later use. A compacted density of the positive electrode plate was 4.23 g/cm³.

### <Preparation of Separator>

The polyethylene (PE) porous polymer film with a thickness of 7 μm was used as a separator.

### <Preparation of Electrolyte Solution>

In a dry argon atmosphere glove box, the compound A fluoroethylene carbonate, the compound B ethylene sulfite, and the non-aqueous solvent diethyl carbonate were mixed to obtain a base solvent, then lithium salt lithium hexafluorophosphate (LiPF₆) was added to the base solvent and fully mixed to uniformity to obtain an electrolyte solution. Based on a mass of the electrolyte solution, a mass percentage of LiPF₆ was 10%, a mass percentage X of the compound A was 8%, a mass percentage Y of the compound B was 5%, and the remainder was the non-aqueous solvent.

### <Preparation of Lithium-Ion Battery>

The prepared positive electrode plate, separator, and negative electrode plate were stacked in sequence, so that the separator was placed between the positive electrode and the negative electrode for separation. A thus formed stack was wound and welded with tabs, and then placed in an outer packaging foil aluminum plastic film. Then the prepared electrolyte solution was injected, followed by processes such as vacuum packaging, standing, formation, degassing, and slitting, to obtain a lithium-ion battery. The formation step was as follows: At an ambient temperature of 25° C., a lithium-ion battery was charged to 4.45 V at a constant current of 0.7 C, charged to 0.025 C at a constant voltage of 4.45 V, left standing for 5 minutes, and discharged to 3.0 V at 0.5 C.

### Examples 1-2 to 1-14

These examples were the same as Example 1-1 except that the related parameters were adjusted according to Table 1. When the mass percentage M of the solid electrolyte material Li₃ₓLa_{2/3-x}TiO₃ and the mass percentage N of the solid electrolyte material Li_{1+y}Al_{y}Ti_{2-y}(PO₄)₃ changed, the mass percentage of the negative electrode active material changed accordingly, and the mass percentages of the negative electrode binder, conductive agent, and dispersant remained unchanged. The mass ratio of artificial graphite to silicon in the negative electrode active material remained unchanged.

### Examples 1-15 to 1-22

These examples were the same as Example 1-1 except that the related parameters were adjusted according to Table 1. When the mass percentage R of the negative electrode binder changed, the mass percentage of the negative electrode active material changed accordingly, and the mass percentages of the solid electrolyte material, conductive agent, and dispersant remained unchanged. The mass ratio of artificial graphite to silicon in the negative electrode active material remained unchanged.

### Examples 2-1 to 2-19

These examples were the same as Example 1-1 except that the related parameters were adjusted according to Table 2. When the percentage X of the compound A and/or the percentage Y of the compound B changed, the mass percentage of the non-aqueous solvent changed accordingly, and the mass percentage of the lithium salt remained unchanged.

### Examples 3-1 to 3-3

These examples were the same as Example 1-1 except that the related parameters were adjusted according to Table 3.

### Example 3-4

This example was the same as Example 1-1 except that the negative electrode plate was prepared according to steps below and that the related parameters were adjusted according to Table 3.

### <Preparation of Negative Electrode Plate>

A negative electrode active material was mixed with solid electrolyte Li_{0.3}La_{0.567}TiO₃, then a mixture of the negative electrode active material and the solid electrolyte material, negative electrode binder styrene-butadiene rubber, conductive agent conductive carbon black, and dispersant sodium carboxymethyl cellulose were mixed at a mass ratio of 96:3:0.5:0.5, added with deionized water as a solvent, and stirred to uniformity to obtain a negative electrode slurry with a solid content of 70 wt %. The negative electrode slurry was uniformly applied on one surface of a negative electrode current collector copper foil with a thickness of 6 μm and dried at 120° C., to obtain a negative electrode plate having a negative electrode material layer coated on a single surface with a coating weight CW of 8 mg/cm². Then the foregoing operation steps were repeated on the other surface of the negative electrode current collector copper foil to obtain a negative electrode plate having a negative electrode material layer coated on two surfaces. The coated negative electrode plate was cold-pressed to obtain a negative electrode plate with a compacted density of 1.75 g/cm³. Then the negative electrode plate was cut in dimensions of 74 mm×800 mm for later use. The negative electrode active material was a mixture of artificial graphite and silicon, and a mass ratio of artificial graphite and silicon was 1:1. Based on the mass of the negative electrode material layer, the mass percentage M of the solid electrolyte material Li_{0.3}La_{0.567}TiO₃ was 2%, the mass percentage R of the negative electrode binder was 3%, the mass percentage a of lanthanum was 0.890%, and the mass percentage b of titanium was 0.543%.

### Comparative Example 1

This comparative example was the same as Example 1-1 except that the negative electrode plate was prepared using steps below.

### <Preparation of Negative Electrode Plate>

A mixture of negative electrode active materials artificial graphite and silicon, the negative electrode binder styrene-butadiene rubber, the conductive agent conductive carbon black, and the dispersant sodium carboxymethyl cellulose were mixed at a mass ratio of 96:3:0.5:0.5, added with deionized water as a solvent, and stirred to uniformity to obtain a negative electrode slurry with a solid content of 70 wt %. The negative electrode slurry was uniformly applied on one surface of a negative electrode current collector copper foil with a thickness of 6 μm and dried at 120° C., to obtain a negative electrode plate having a negative electrode material layer coated on a single surface with a coating weight CW of 8 mg/cm². Then the foregoing operation steps were repeated on the other surface of the negative electrode current collector copper foil to obtain a negative electrode plate having a negative electrode material layer coated on two surfaces. The coated negative electrode plate was cold-pressed to obtain a negative electrode plate with a compacted density of 1.75 g/cm³. Then the negative electrode plate was cut in dimensions of 74 mm×800 mm for later use. The mass ratio of artificial graphite and silicon in the negative electrode active material was 1:1.

### Comparative Example 2 and 3

These comparative examples were the same as Example 1-1 except that the related parameters were adjusted according to Table 1.

### Comparative Example 4 and 5

These examples were the same as Comparative example 1 except that the related parameters were adjusted according to Table 1.

The related parameters and performance result tests of examples and comparative examples are shown in Table 1 to Table 3.

TABLE 1

| | | | | | | | | | | | | | Discharge | |
|---|---|---|---|---|---|---|---|---|---|---|---|---|---|---|
| | | | | | | | | | | | | | capacity | Number |
| | | | | | | | | Negative | | | | Swelling | retention | of |
| | a | b | | M | | N | R | electrode | Z | | Impedance | rate | rate at | cycles |
| | (%) | (%) | x | (%) | y | (%) | (%) | binder | (N/m) | a/Z | (mΩ) | (%) | 3C (%) | (cls) |
| Example | 0.890 | 0.543 | 0.1 | 2 | / | / | 3 | Styrene- | 26.3 | 3.387 × 10⁻⁴ | 52.3 | 10.8 | 92.8 | 358 |
| 1-1 | | | | | | | | butadiene | | | | | | |
| | | | | | | | | rubber | | | | | | |
| Example | 0.840 | 0.562 | 0.15 | 2 | / | / | 3 | Styrene- | 25.3 | 3.321 × 10⁻⁴ | 52.4 | 10.9 | 92.6 | 352 |
| 1-2 | | | | | | | | butadiene | | | | | | |
| | | | | | | | | rubber | | | | | | |
| Example | 0.786 | 0.582 | 0.2 | 2 | / | / | 3 | Styrene- | 24.7 | 3.182 × 10⁻⁴ | 52.6 | 11.1 | 92.5 | 352 |
| 1-3 | | | | | | | | butadiene | | | | | | |
| | | | | | | | | rubber | | | | | | |
| Example | 0.728 | 0.603 | 0.25 | 2 | / | / | 3 | Styrene- | 24.1 | 3.020 × 10⁻⁴ | 52.9 | 11.3 | 92.43 | 351 |
| 1-4 | | | | | | | | butadiene | | | | | | |
| | | | | | | | | rubber | | | | | | |
| Example | 0.665 | 0.626 | 0.3 | 2 | / | / | 3 | Styrene- | 24 | 2.771 × 10⁻⁴ | 53.2 | 11.4 | 92.41 | 350 |
| 1-5 | | | | | | | | butadiene | | | | | | |
| | | | | | | | | rubber | | | | | | |
| Example | 0.196 | 0.145 | 0.2 | 0.5 | / | / | 3 | Styrene- | 20.9 | 9.378 × 10⁻³ | 53.8 | 10.82 | 92.3 | 350 |
| 1-6 | | | | | | | | butadiene | | | | | | |
| | | | | | | | | rubber | | | | | | |
| Example | 1.571 | 1.163 | 0.2 | 4 | / | / | 3 | Styrene- | 28.5 | 5.51 × 10⁻⁴ | 49.8 | 10.6 | 93.2 | 359 |
| 1-7 | | | | | | | | butadiene | | | | | | |
| | | | | | | | | rubber | | | | | | |
| Example | 1.965 | 1.454 | 0.2 | 5 | / | / | 3 | Styrene- | 29.1 | 6.75 × 10⁻⁴ | 49.6 | 10.6 | 93.22 | 361 |
| 1-8 | | | | | | | | butadiene | | | | | | |
| | | | | | | | | rubber | | | | | | |
| Example | 3.930 | 2.908 | 0.2 | 10 | / | / | 3 | Styrene- | 29.7 | 1.32 × 10⁻³ | 49.1 | 10.4 | 93.42 | 367 |
| 1-9 | | | | | | | | butadiene | | | | | | |
| | | | | | | | | rubber | | | | | | |
| Example | 4.453 | 2.714 | 0.1 | 10 | / | / | 3 | Styrene- | 29.9 | 1.49 × 10⁻³ | 49.1 | 10.2 | 93.43 | 368 |
| 1-10 | | | | | | | | butadiene | | | | | | |
| | | | | | | | | rubber | | | | | | |
| Example | 0.166 | 0.157 | 0.3 | 0.5 | / | / | 3 | Styrene- | 19.4 | 8.55 × 10⁻⁵ | 53.84 | 11.51 | 92.31 | 348 |
| 1-11 | | | | | | | | butadiene | | | | | | |
| | | | | | | | | rubber | | | | | | |
| Example | 3.13 | 3.2 | 0.33 | 10 | / | / | 3 | Styrene- | 31 | 1.01 × 10⁻³ | 50.14 | 10.3 | 93.18 | 345 |
| 1-12 | | | | | | | | butadiene | | | | | | |
| | | | | | | | | rubber | | | | | | |
| Example | 0.891 | 0.968 | 0.1 | 2 | 0.3 | 2 | 3 | Styrene- | 27.8 | 3.21 × 10⁻⁴ | 49.32 | 10.21 | 93.06 | 359 |
| 1-13 | | | | | | | | butadiene | | | | | | |
| | | | | | | | | rubber | | | | | | |
| Example | 0.891 | 0.921 | 0.1 | 2 | 0.5 | 2 | 3 | Styrene- | 28.3 | 3.15 × 10⁻⁴ | 49.14 | 10.16 | 93.14 | 363 |
| 1-14 | | | | | | | | butadiene | | | | | | |
| | | | | | | | | rubber | | | | | | |
| Example | 0.891 | 0.543 | 0.1 | 2 | / | / | 1.8 | Styrene- | 14.6 | 6.10 × 10⁻⁴ | 58.9 | 12.8 | 89.1 | 284 |
| 1-15 | | | | | | | | butadiene | | | | | | |
| | | | | | | | | rubber | | | | | | |
| Example | 0.891 | 0.543 | 0.1 | 2 | / | / | 5 | Styrene- | 35.4 | 2.52 × 10⁻⁴ | 54.5 | 10.1 | 90.1 | 312 |
| 1-16 | | | | | | | | butadiene | | | | | | |
| | | | | | | | | rubber | | | | | | |
| Example | 0.891 | 0.543 | 0.1 | 2 | / | / | 7 | Styrene- | 38.9 | 2.29 × 10⁻⁴ | 56.5 | 10 | 88.1 | 295 |
| 1-17 | | | | | | | | butadiene | | | | | | |
| | | | | | | | | rubber | | | | | | |
| Example | 0.891 | 0.543 | 0.1 | 2 | / | / | 9.8 | Styrene- | 41.1 | 2.17 × 10⁻⁴ | 60.5 | 9.88 | 85.1 | 273 |
| 1-18 | | | | | | | | butadiene | | | | | | |
| | | | | | | | | rubber | | | | | | |
| Example | 0.891 | 0.543 | 0.1 | 2 | / | / | 1.5 | Styrene- | 11.1 | 8.03 × 10⁻⁴ | 59.2 | 13.1 | 86.1 | 282 |
| 1-19 | | | | | | | | butadiene | | | | | | |
| | | | | | | | | rubber | | | | | | |
| Example | 0.891 | 0.543 | 0.1 | 2 | / | / | 11 | Styrene- | 45.2 | 1.97 × 10⁻⁴ | 61.3 | 9.48 | 83.4 | 253 |
| 1-20 | | | | | | | | butadiene | | | | | | |
| | | | | | | | | rubber | | | | | | |
| Example | 0.890 | 0.543 | 0.1 | 2 | / | / | 3 | Polyacrylate | 23.7 | 3.76 × 10⁻⁴ | 52.9 | 11.6 | 92.2 | 351 |
| 1-21 | | | | | | | | | | | | | | |
| Example | 0.890 | 0.543 | 0.1 | 2 | / | / | 3 | Polyacry- | 22.3 | 3.99 × 10⁻⁴ | 53.3 | 11.8 | 92.3 | 349 |
| 1-22 | | | | | | | | lonitrile | | | | | | |
| Comparative | / | / | / | / | / | / | 3 | Styrene- | 23 | / | 68.7 | 14 | 78.1 | 163 |
| example 1 | | | | | | | | butadiene | | | | | | |
| | | | | | | | | rubber | | | | | | |
| Comparative | 0.1 | 0.06 | 0.1 | 0.22 | / | / | 3 | Styrene- | 21.7 | 4.61 × 10⁻⁵ | 55.7 | 13.6 | 82 | 176 |
| example 2 | | | | | | | | butadiene | | | | | | |
| | | | | | | | | rubber | | | | | | |
| Comparative | 5.4 | 5.07 | 0.3 | 16.2 | / | / | 3 | Styrene- | 45.2 | 1.19 × 10⁻³ | 69.1 | 10.1 | 81.1 | 193 |
| example 3 | | | | | | | | butadiene | | | | | | |
| | | | | | | | | rubber | | | | | | |
| Comparative | / | / | / | / | / | / | 1 | Styrene- | 10 | / | 64.9 | 15.9 | 82.1 | 212 |
| example 4 | | | | | | | | butadiene | | | | | | |
| | | | | | | | | rubber | | | | | | |
| Comparative | / | / | / | / | / | / | 13 | Styrene- | 50 | / | 71.5 | 9.41 | 72.1 | 181 |
| example 5 | | | | | | | | butadiene | | | | | | |
| | | | | | | | | rubber | | | | | | |

Note:
“/” in Table 1 means that a related preparation parameter does not exist.

It can be seen from Examples 1-1 to 1-11 and Comparative example 1 to 5 that the solid electrolyte material is added to the negative electrode material layer so that the mass percentage of lanthanum and the cohesion of the negative electrode material layer are within the ranges in this application, the impedance of the lithium-ion battery is lowered, the discharge capacity retention rate at 3 C and the number of cycles are increased, and the swelling rate of the lithium-ion battery is reduced. This indicates that the lithium-ion battery of this application has good rate performance and cycling performance. It can be seen from Examples 1-1 to 1-11 and Comparative example 1 that when no solid electrolyte is added to the negative electrode material layer, the impedance of the lithium-ion battery is higher, the discharge capacity retention rate at 3 C is lower, the number of cycles is fewer, and the swelling rate of the lithium-ion battery is higher. The obtained lithium-ion battery has poor rate performance and cycling performance. It can be seen from Examples 1-1 to 1-11 and Comparative examples 2 and 3 that when the mass percentage of lanthanum is not within the range in this application, even if the solid electrolyte material is added to the negative electrode material layer, for the lithium-ion battery, the discharge capacity retention rate at 3 C is lower, and the number of cycles is fewer. The obtained lithium-ion battery had poor rate performance and cycling performance. It can be seen from Examples 1-1 to 1-11 and Comparative examples 4 and 5 that when no solid electrolyte is added to the negative electrode material layer and the cohesion of the negative electrode material layer is not within the range in this application, even if the swelling rate of the lithium-ion battery is reduced as the amount of the negative electrode binder added is increased, the impedance of the lithium-ion battery is larger, the discharge capacity retention rate at 3 C is lower, and the number of cycles is fewer. This thus indicates that the lithium-ion battery in the embodiments of this application has good rate performance and cycling performance.

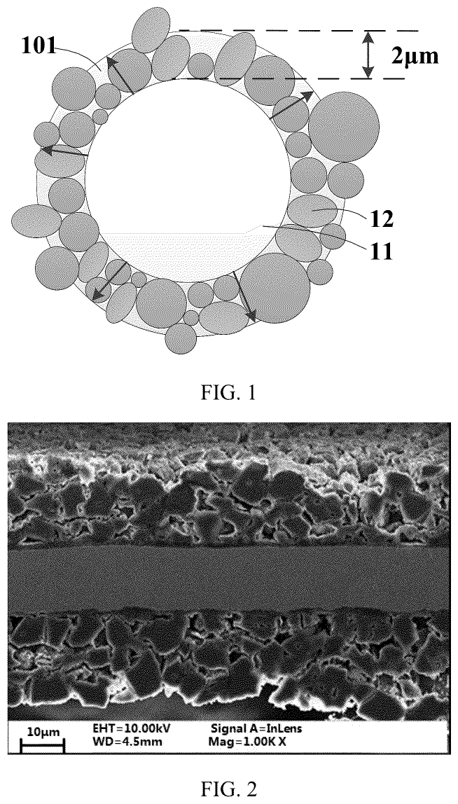

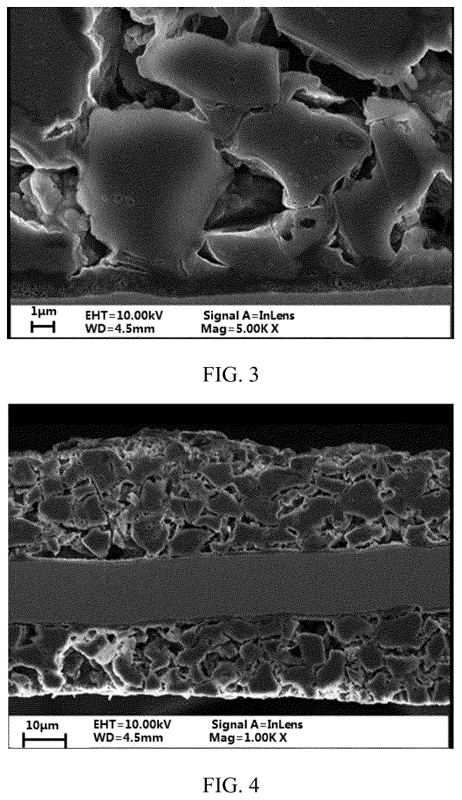

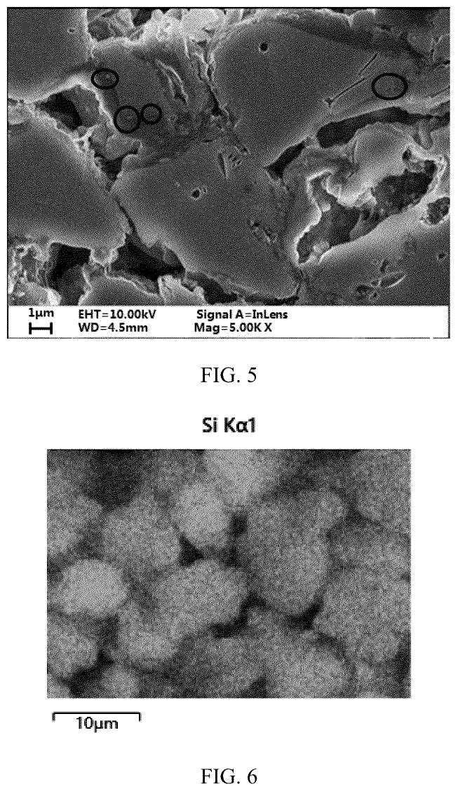

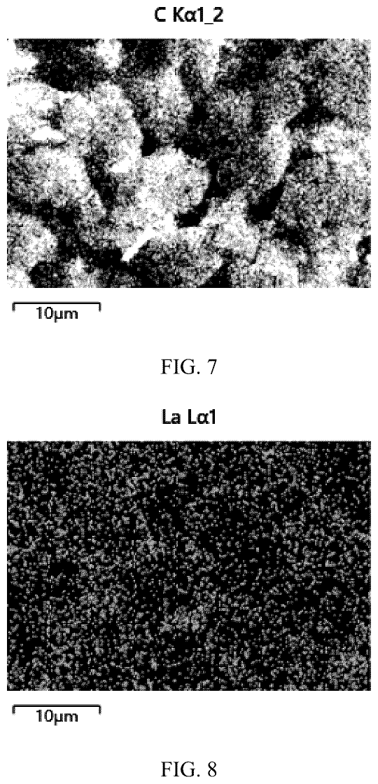

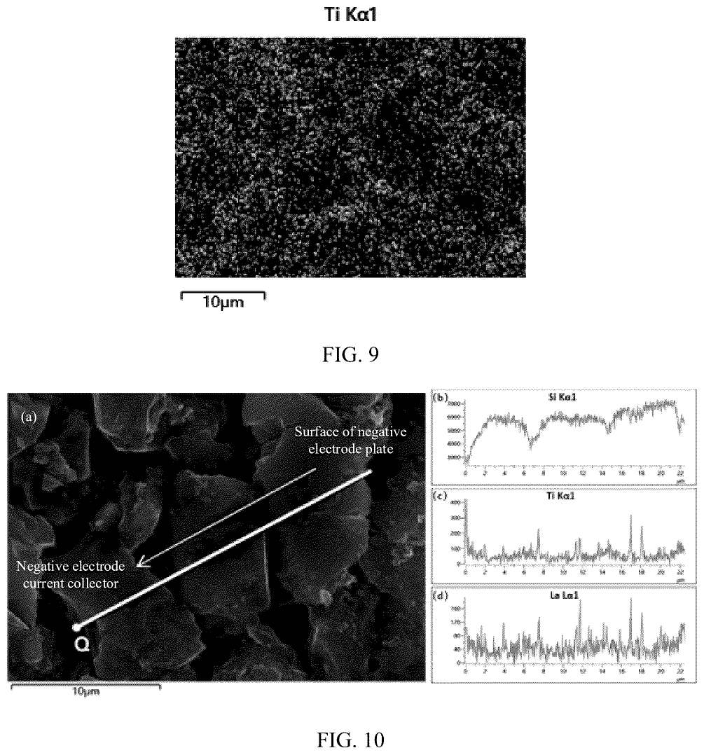

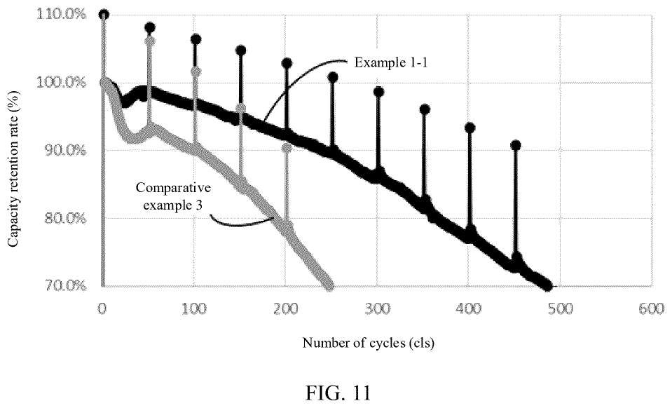

It can be seen from FIG. 2 to FIG. 5 that, as compared with Comparative example 1, the number of small particles in the negative electrode material layer of Example 1-1 is increased. As shown in FIG. 5, the black circles indicate the solid electrolyte material, and the solid electrolyte material is distributed on the surface of the particles of the negative electrode active material and is relatively uniform. This indicates that the distribution of the solid electrolyte material in Example 1-1 is relatively uniform in the negative electrode material layer. Further, it can be seen from FIG. 6 to FIG. 9 that elements Si, C, La, and Ti are present on the surface of the negative electrode active material particles and are relatively uniform in distribution. This indicates that the distribution of the solid electrolyte material in Example 1-1 is relatively uniform in the negative electrode material layer. It can be seen from FIG. 10 that elements Si, La, and Ti are distributed on test line segment Q, and that the dispersion of the solid electrolyte material is relatively uniform in the negative electrode material layer. It can be seen from FIG. 11 that the lithium-ion battery in Example 1-1 has a capacity retention rate of less than 80% after 358 cycles, and the capacity retention rate of the lithium-ion battery is reduced slowly as the number of cycles increases; while the lithium-ion battery in Comparative example 3 already has a capacity retention rate of less than 80% after 193 cycles. This indicates that the lithium-ion battery in the examples of this application has better cycling performance.

The mass percentage b of titanium in the negative electrode material layer usually affects the rate performance and cycling performance of the lithium-ion battery. It can be seen from Examples 1-1 to 1-12 that when the mass percentage b of titanium in the negative electrode material layer is within the range in this application, for the lithium-ion battery, the impedance is low, the discharge capacity retention rate at 3 C is high, the number of cycles is large, and the swelling rate is low. This indicates that the lithium-ion battery of this application has good rate performance and cycling performance. The impedance and swelling rate of the lithium-ion battery in Example 1-12 are lower than those in Example 1-11, and the discharge capacity retention rate at 3 C is higher than that in Example 1-11. However, the percentage of titanium in Example 1-12 is higher, indicating that the solid electrolyte material in the lithium-ion battery is higher in percentage and occupies space for the liquid electrolyte solution to some extent, and the ionic conductance of the solid electrolyte material is lower than that of the electrolyte solution, resulting in a smaller number of cycles of the lithium-ion battery.

The type of the solid electrolyte material usually affects the rate performance and cycling performance of the lithium-ion battery. It can be seen from Example 1-1, Example 1-5, and Examples 1-13 and 1-14 that when the type of the solid electrolyte material is within the range in this application, for the lithium-ion battery, the impedance is low, the discharge capacity retention rate at 3 C is high, the number of cycles is large, and the swelling rate is low. This indicates that the lithium-ion battery of this application has good rate performance and cycling performance.

The type and percentage of the negative electrode binder usually affect the rate performance and cycling performance of the lithium-ion battery. It can be seen from Example 1-1 and Examples 1-15 to 1-22 that when the type and percentage of the negative electrode binder are within the ranges in this application, for the lithium-ion battery, the impedance is low, the discharge capacity retention rate at 3 C is high, the number of cycles is large, and the swelling rate is low. This indicates that the lithium-ion battery of this application has good rate performance and cycling performance.

TABLE 2

| | | | | | Dry | Stirring | | |
|---|---|---|---|---|---|---|---|---|
| | | X | | Y | power | time | M | a1 |
| | Compound A | (%) | Compound B | (%) | stirring? | (min) | (%) | (%) |
| Example 1-1 | Fluoroethylene | 8 | Ethylene | 5 | Yes | 30 | 2 | 0.76 |
| | carbonate | | sulfite | | | minutes | | |
| Example 2-1 | Fluoroethylene | 3.5 | / | / | Yes | 30 | 2 | 0.73 |
| | carbonate | | | | | | | |
| Example 2-2 | Fluoroethylene | 13.5 | / | / | Yes | 30 | 2 | 0.77 |
| | carbonate | | | | | minutes | | |
| Example 2-3 | Fluoroethylene | 3 | / | / | Yes | 30 | 2 | 0.73 |
| | carbonate | | | | | minutes | | |
| Example 2-4 | Fluoroethylene | 14 | / | / | Yes | 30 | 2 | 0.78 |
| | carbonate | | | | | minutes | | |
| Example 2-5 | Fluoroethylene | 3.5 | / | / | Yes | 30 | 9.8 | 4 |
| | carbonate | | | | | minutes | | |
| Example 2-6 | Fluoroethylene | 13.5 | / | / | Yes | 5 | 2 | 0.12 |
| | carbonate | | | | | minutes | | |
| Example 2-7 | Vinylene | 8 | / | / | Yes | 30 | 2 | 0.74 |
| | carbonate | | | | | minutes | | |
| Example 2-8 | Vinyl ethylene | 8 | / | / | Yes | 30 | | 0.76 |
| | carbonate | | | | | minutes | | |
| Example 2-9 | Fluoroethylene | 8 | / | / | Yes | 30 | 2 | 0.77 |
| | carbonate + | | | | | minutes | | |
| | viaylene | | | | | | | |
| | carbonate | | | | | | | |
| | (maas ratio | | | | | | | |
| | of 1:1) | | | | | | | |
| Example 2-10 | / | / | Ethylene | 1.2 | Yes | 30 | 2 | 0.75 |
| | | | sulfite | | | minutes | | |
| Example 2-11 | / | / | Ethylene | 6.5 | Yes | 30 | 2 | 0.75 |
| | | | sulfite | | | minutes | | |
| Example 2-12 | / | / | Ethylene | 0.5 | Yes | 30 | 2 | 0.76 |
| | | | sulfite | | | minutes | | |
| Example 2-13 | / | / | Ethylene | 7.5 | Yes | 30 | 2 | 0.77 |
| | | | sulfite | | | minutes | | |
| Example 2-14 | / | / | 1,3-propane | 5 | Yes | 30 | 2 | 0.76 |
| | | | sultone | | | minutes | | |
| Example 2-15 | / | / | Ethylene | 5 | Yes | 30 | 2 | 0.77 |
| | | | sulfate | | | minutes | | |
| Example 2-16 | / | / | Ethylene | 5 | Yes | 30 | 2 | 0.76 |
| | | | sulfite + | | | minutes | | |
| | | | ethylene | | | | | |
| | | | sulfate (mass | | | | | |
| | | | ratio of 1:1) | | | | | |
| Example 2-17 | Vinyl ethylene | 8 | Ethylene | 5 | Yes | 30 | 2 | 0.78 |
| | carbonate | | sulfate | | | minutes | | |
| Example 2-18 | Flooroethylene | 8 | Ethylene | 1.54 | Yes | 30 | 2 | 0.76 |
| | carbonate | | sulfite | | | minutes | | |
| Example 2-19 | Floroethylene | 8 | Ethylene | 6.5 | Yes | 5 | 2 | 0.12 |
| | carbonate | | sulfite | | | minutes | | |

| | | | | | | Discharge | |
|---|---|---|---|---|---|---|---|
| | | | | | | capacity | Number |
| | | X/ | Y/ | | | retention | of |
| | b1 | (a1 + | (a1 + | Impedance | Swelling | rate at | cycles |
| | (%) | b1) | b1) | (mΩ) | rate (%) | 30 (%) | (cls) |
| Example 1-1 | 0.47 | 6.504 | 4.065 | 52.3 | 10.8 | 92.8 | 358 |
| Example 2-1 | 0.45 | 2.966 | / | 54.3 | 11 | 92.4 | 351 |
| Example 2-2 | 0.48 | 10.8 | / | 51 | 10.3 | 93.1 | 363 |
| Example 2-3 | 0.45 | 2.542 | / | 56.2 | 11.4 | 92.1 | 347 |
| Example 2-4 | 0.49 | 11.024 | / | 54.9 | 11.3 | 92 | 322 |
| Example 2-5 | 1.2 | 0.67 | / | 46.6 | 9.3 | 93.3 | 366 |
| Example 2-6 | 0.08 | 67.5 | / | 60.1 | 13.6 | 91.1 | 312 |
| Example 2-7 | 0.45 | 6.723 | / | 51.8 | 10.7 | 92.9 | 359 |
| Example 2-8 | 0.48 | 6.452 | / | 52.1 | 10.7 | 92.7 | 360 |
| Example 2-9 | 0.47 | 6.452 | / | 52.4 | 10.6 | 92.9 | 359 |
| Example 2-10 | 0.45 | / | 1 | 51.9 | 11 | 92.5 | 351 |
| Example 2-11 | 0.48 | / | 5.285 | 52.8 | 11.2 | 92.3 | 349 |
| Example 2-12 | 0.45 | / | 0.413 | 58.9 | 13.4 | 91.2 | 316 |
| Example 2-13 | 0.48 | / | 5 | 58.4 | 12.9 | 91.4 | 309 |
| Example 2-14 | 0.44 | / | 4.167 | 51.6 | 11.4 | 92.3 | 345 |
| Example 2-15 | 0.46 | / | 4.065 | 52.1 | 10.9 | 93.1 | 356 |
| Example 2-16 | 0.46 | / | 4.464 | 51.6 | 11.2 | 92.5 | 362 |
| Example 2-17 | 0.46 | 6.452 | 4.032 | 50.7 | 10.2 | 93.4 | 364 |
| Example 2-18 | 0.47 | 6.5 | 1.25 | 56.3 | 12.8 | 92.1 | 328 |
| Example 2-19 | 0.08 | 40 | 32.5 | 58.7 | 13.3 | 91.6 | 321 |

Note:
“/” in Table 2 means that a related preparation parameter does not exist.

The type and mass percentage of compound A in the electrolyte solution and the value of X/(a1+b1) usually affect the rate performance and cycling performance of the lithium-ion battery. It can be seen from Example 1-1, Examples 2-1 to 2-9, and Examples 2-17 to 2-19 that when the type and mass percentage of compound A in the electrolyte solution and the value of X/(a1+b1) are within the ranges in this application, for the lithium-ion battery, the impedance is low, the discharge capacity retention rate at 3 C is high, the number of cycles is large, and the swelling rate is low. This indicates that the lithium-ion battery of this application has good rate performance and cycling performance.

The type and mass percentage of compound B in the electrolyte solution and the value of Y/(a1+b1) usually affect the rate performance and cycling performance of the lithium-ion battery. It can be seen from Example 1-1, and Examples 2-10 to 2-19 that when the type and mass percentage of compound B in the electrolyte solution and the value of y/(a1+b1) are within the ranges in this application, for the lithium-ion battery, the impedance is low, the discharge capacity retention rate at 3 C is high, the number of cycles is large, and the swelling rate is low. This indicates that the lithium-ion battery of this application has good rate performance and cycling performance.

TABLE 3

| | | | | | | | | Discharge | |
|---|---|---|---|---|---|---|---|---|---|
| | | | | | | | | capacity | Number |
| | Dry | Stirring | | | | | Swelling | retention | of |
| | power | time | M | a1 | b1 | Impedance | rate | rate at | cycles |
| | stirring? | (min) | (%) | (%) | (%) | (mΩ) | (%) | 3C (%) | (cls) |
| Exampl | Yes | 30 | 2 | 0.7 | 0.4 | 52.3 | 10.8 | 92.8 | 358 |
| e 1-1 | | | | 6 | 7 | | | | |
| Example | Yes | 5 | 2 | 0.12 | 0.08 | 55.6 | 11.3 | 92.3 | 327 |
| 3-1 | | | | | | | | | |
| Example | Yes | 120 | 2 | 1.2 | 0.9 | 50.1 | 10.2 | 93.2 | 363 |
| 3-2 | | | | | | | | | |
| Example | Yes | 30 | 9.8 | 4 | 1.2 | 49.5 | 10.1 | 93.4 | 366 |
| 3-3 | | | | | | | | | |
| Example | No | / | 2 | 0.08 | 0.05 | 60.3 | 11.8 | 92.1 | 305 |
| 3-4 | | | | | | | | | |

Note:
“/” in Table 3 means that a related preparation parameter does not exist.

The mass percentage a1 of lanthanum and the mass percentage b1 of titanium in the external region usually affect the rate performance and cycling performance of the lithium-ion battery. It can be seen from Example 1-1 and Examples 3-1 to 3-4 that when the mass percentage a1 of lanthanum and the mass percentage b1 of titanium in the external region are within the range in this application, for the lithium-ion battery, the impedance is low, the discharge capacity retention rate at 3 C is high, the number of cycles is large, and the swelling rate is low. This indicates that the lithium-ion battery of this application has good rate performance and cycling performance.

The terms “include”, “comprise”, or any other variants thereof are intended to cover a non-exclusive inclusion, such that a process, method, or article that includes a series of elements includes not only those elements but also other elements that are not expressly listed, or further includes elements inherent to such process, method, or article.

Some embodiments in this specification are described in a related manner. For a part that is the same or similar between these embodiments, reference may be made between these embodiments. Each embodiment focuses on differences from other embodiments.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A secondary battery, comprising a negative electrode plate; wherein the negative electrode plate comprises a negative electrode current collector and a negative electrode material layer disposed on at least one surface of the negative electrode current collector, and a cohesion of the negative electrode material layer is Z N/m, wherein 15≤Z≤45; and
the negative electrode material layer comprises a negative electrode active material, a solid electrolyte material, and a negative electrode binder; the solid electrolyte material contains lanthanum; and based on a mass of the negative electrode material layer, a mass percentage of lanthanum is a, wherein 0.16%≤a≤5%.

2. The secondary battery according to claim 1, wherein 5.5×10⁻⁵≤a/Z≤1.5×10⁻³.

3. The secondary battery according to claim 1, wherein 19.4≤Z≤29.9.

4. The secondary battery according to claim 1, wherein 0.166%≤a≤1.965%.

5. The secondary battery according to claim 1, wherein 2.5×10⁻⁴≤a/Z≤6×10⁻⁴.

6. The secondary battery according to claim 1, wherein the solid electrolyte material comprises Li₃ₓLa_{2/3-x}TiO₃, wherein 0.1≤x≤0.3.

7. The secondary battery according to claim 6, wherein the solid electrolyte material further comprises Li_{1+y}Al_{y}Ti_{2-y}(PO₄)₃, wherein 0<y≤0.5.

8. The secondary battery according to claim 1, wherein the solid electrolyte material contains titanium; and based on the mass of the negative electrode material layer, a mass percentage of titanium is b, wherein 0.08%≤b≤3%.

9. The secondary battery according to claim 1, wherein a region located on outer part of a particle of the negative electrode active material and within 2 μm from a surface of the particle of the negative electrode active material is an external region, the external region contains lanthanum and titanium; and based on the mass of the negative electrode material layer, a mass percentage of lanthanum in the external region is a1, wherein 0.12%≤a1≤4%, and a mass percentage of titanium in the external region is b1, wherein 0.08%≤b1≤1.2%.

10. The secondary battery according to claim 9, wherein 0.12%≤a1≤1.2%.

11. The secondary battery according to claim 9, wherein 0.08%≤b1≤0.9%.

12. The secondary battery according to claim 9, wherein the electrolyte solution comprises a compound A; wherein the compound A comprises at least one selected from the group consisting of fluoroethylene carbonate, vinylene carbonate, and vinyl ethylene carbonate; and based on a mass of the electrolyte solution, a mass percentage of the compound A is X, wherein 3.5%≤X≤13.5%, and 0.67≤X/(a1+b1)≤67.5.

13. The secondary battery according to claim 9, wherein the electrolyte solution comprises a compound B; wherein the compound B comprises at least one selected from the group consisting of propylene sulfite, 1,3-propane sultone, and ethylene sulfate; and based on the mass of the electrolyte solution, a mass percentage of the compound B is Y, wherein 1.2%≤Y≤6.5%, and 1.25≤Y/(a1+b1)≤32.5.

14. The secondary battery according to claim 1, wherein the negative electrode material layer comprises a negative electrode binder; the negative electrode binder comprises at least one selected from the group consisting of polyacrylate, polyimide, polyamide, polyamideimide, polyvinylidene fluoride, styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, and potassium hydroxymethyl cellulose; and based on the mass of the negative electrode material layer, a mass percentage of the negative electrode binder is 1.8% to 9.8%.

15. An electronic apparatus, comprising a secondary battery; wherein the secondary battery comprises a negative electrode current collector and a negative electrode material layer disposed on at least one surface of the negative electrode current collector, and a cohesion of the negative electrode material layer is Z N/m, wherein 15≤Z≤45; and
the negative electrode material layer comprises a negative electrode active material, a solid electrolyte material, and a negative electrode binder; the solid electrolyte material contains lanthanum; and based on a mass of the negative electrode material layer, a mass percentage of lanthanum is a, wherein 0.16%≤a≤5%.

16. The electronic apparatus according to claim 15, wherein 5.5×10⁻⁵≤a/Z≤1.5×10⁻³.

17. The electronic apparatus according to claim 15, wherein a region located on outer part of a particle of the negative electrode active material and within 2 μm from a surface of the particle of the negative electrode active material is an external region, the external region contains lanthanum and titanium; and based on the mass of the negative electrode material layer, a mass percentage of lanthanum in the external region is a1, wherein 0.12%≤a1≤4%, and a mass percentage of titanium in the external region is b1, wherein 0.08%≤b1≤1.2%.

18. The electronic apparatus according to claim 17, wherein the electrolyte solution comprises a compound A; wherein the compound A comprises at least one selected from the group consisting of fluoroethylene carbonate, vinylene carbonate, and vinyl ethylene carbonate; and based on a mass of the electrolyte solution, a mass percentage of the compound A is X, wherein 3.5%≤X≤13.5%, and 0.67≤X/(a1+b1)≤67.5.

19. The electronic apparatus according to claim 17, wherein the electrolyte solution comprises a compound B; wherein the compound B comprises at least one selected from the group consisting of propylene sulfite, 1,3-propane sultone, and ethylene sulfate; and based on the mass of the electrolyte solution, a mass percentage of the compound B is Y, wherein 1.2%≤Y≤6.5%, and 1.25≤Y/(a1+b1)≤32.5.

20. The electronic apparatus according to claim 15, wherein the negative electrode material layer comprises a negative electrode binder; the negative electrode binder comprises at least one selected from the group consisting of polyacrylate, polyimide, polyamide, polyamideimide, polyvinylidene fluoride, styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, and potassium hydroxymethyl cellulose; and based on the mass of the negative electrode material layer, a mass percentage of the negative electrode binder is 1.8% to 9.8%.
